(19) United States
(12) Patent Application Publication
(10) Pub. No.: US 2024/0161160 A1
(43) Pub. Date: May 16, 2024

(54) PAYMENT INFRASTRUCTURE FOR MOBILITY

(71) Applicant: Wells Fargo Bank, N.A., San Francisco, CA (US)

(72) Inventors: Anthony Adam Swider, III, Roxbury, CT (US); Todd Thomas, Charlotte, NC (US); William Bondar, Avon Lake, OH (US); Eric J. Miller, Minneapolis, MN (US); Robert Glenn Hamchuk, San Jose, CA (US); James D. Cahill, Milwaukie, OR (US); Benjamin Taylor, Williston, VT (US); Young M Yang, San Francisco, CA (US); Allison R. King, Baltimore, MD (US)

(21) Appl. No.: 18/511,653

(22) Filed: Nov. 16, 2023

Related U.S. Application Data
(60) Provisional application No. 63/384,032, filed on Nov. 16, 2022.

(51) Int. Cl. G06Q 30/06; G06Q 40/02; G06Q 50/30

(52) U.S. Cl. CPC G06Q 30/06; G06Q 40/02; G06Q 50/30; G06Q 2240/00

(57) ABSTRACT

Techniques described herein include providing payment and access infrastructure for an array of transportation services, such as a set of transit or mobility services that might be provided by one or more governments, public agencies, and/or other public entities. In one example, this disclosure describes a method that includes enabling, by a computing system, a user to register for mobility benefits using a verification system, wherein the mobility benefits are provided by a provider entity; receiving, by the computing system and from the verification system, information about the user; establishing, by the computing system, an account linked to the provider entity; detecting, by the computing system, a request to access mobility benefits; allocating, by the computing system, funds from the account to pay for the mobility benefits.

### CROSS REFERENCE

This application claims the benefit of U.S. Provisional Patent Application No. 63/384,032 filed on Nov. 16, 2022, which is hereby incorporated by reference herein in its entirety.

### TECHNICAL FIELD

This disclosure relates to computing systems, and more specifically, to techniques for providing access to and/or payment options for transit and mobility services.

### BACKGROUND

Government entities have historically provided (or partnered with private entities to provide) transit services as a public service. As a result, many types of public transit services are available throughout the world, both within and across sovereign boundaries. Some governmental entities have made an effort to integrate their transit services for the convenience of the public. Often, however, many aspects of disparate transit services are not well integrated. For example, in some cities, paying to ride a bus within the city and paying to ride a train in that same city might require two different methods of payment.

### SUMMARY

Techniques described herein include providing payment and access infrastructure for an array of transportation services, such as a set of transit or mobility services that might be provided by one or more governments, public agencies, and/or other entities. In some examples, techniques described herein include systems, processes, and services that might be provided by a bank or financial institution to implement access to transportation services through various payment processes and payment options. Such a bank or financial institution may also provide systems, infrastructure, services, and/or expertise in connection with implementing other aspects of a transportation infrastructure.

In general, techniques described may be applicable to a transit ecosystem that integrates a diverse array of transit options available to consumers of transit services in a particular geographic region. In addition, techniques described herein may be applicable across a diverse set of consumers. For example, for potential consumers of transit services that have limited access to banking services, techniques described herein may enable such consumers to nevertheless conveniently take advantage of transit services that might be provided by a government or other public entity. Similarly, for potential consumers of transit services that have limited access to a mobile smartphone or other mobile device, techniques described herein may enable such consumers to nevertheless take advantage of transit services that might be provided by a government or other public entity. And for potential consumers of transit services that have access to both banking services and modern mobile devices, techniques described herein enable efficient use of such banking services and mobile devices when using transit services.

Techniques described herein include architectures for arrangement of payment services, physical access techniques (e.g., turnstiles at a transit station), virtual access processes (e.g., biometric authentication), techniques for facilitating transportation that involves multiple transit systems (e.g., train, bus), accounting arrangements for allocating funds and/or limiting fund use to specific purposes, processes for encouraging use of transit system during periods of low utilization, processes for encouraging use of transit systems generally, techniques for providing transit consumers with convenient payment, funds allocation, and physical use of transit systems, as well as other techniques.

In some examples, this disclosure describes operations performed by a computing system in accordance with one or more aspects of this disclosure. In one specific example, this disclosure describes a method comprising enabling, by a computing system, a user to register for mobility benefits using a verification system, wherein the mobility benefits are provided by a provider entity; receiving, by the computing system and from the verification system, information about the user; establishing, by the computing system, an account linked to the provider entity; detecting, by the computing system, a request to access mobility benefits from the user; and allocating, by the computing system, funds from the account to pay for the mobility benefits.

In another example, this disclosure describes a system comprising a storage system and processing circuitry having access to the storage system, wherein the processing circuitry is configured to carry out operations described herein. In yet another example, this disclosure describes a computer-readable storage medium comprising instructions that, when executed, configure processing circuitry of a computing system to carry out operations described herein.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1 is a conceptual diagram illustrating an example system for managing, integrating, and/or administering transit infrastructure, in accordance with one or more aspects of the present disclosure.

FIG. 2A is a conceptual diagram illustrating a process by which a user registers to pay for transit services using a credit card, in accordance with one or more aspects of the present disclosure.

FIG. 2B is a conceptual diagram illustrating a process by which a user uses a credit card to pay for transit services, in accordance with one or more aspects of the present disclosure.

FIG. 3 is a conceptual diagram and block diagram illustrating an example computing system for managing, integrating, and/or administrating transit infrastructure, in accordance with one or more aspects of the present disclosure.

FIG. 4A is a conceptual diagram illustrating a process by which a user registers to pay for transit services using an alternative payment method, in accordance with one or more aspects of the present disclosure.

FIG. 4B is a conceptual diagram illustrating a process by which a user uses an alternative payment method to pay for transit services, in accordance with one or more aspects of the present disclosure.

FIG. 5 is a conceptual diagram illustrating a process by which a financial institution allocates funds for transit services to users, in accordance with one or more aspects of the present disclosure.

FIG. 6 is a flow diagram illustrating operations performed by an example computing system in accordance with one or more aspects of the present disclosure.

### DETAILED DESCRIPTION

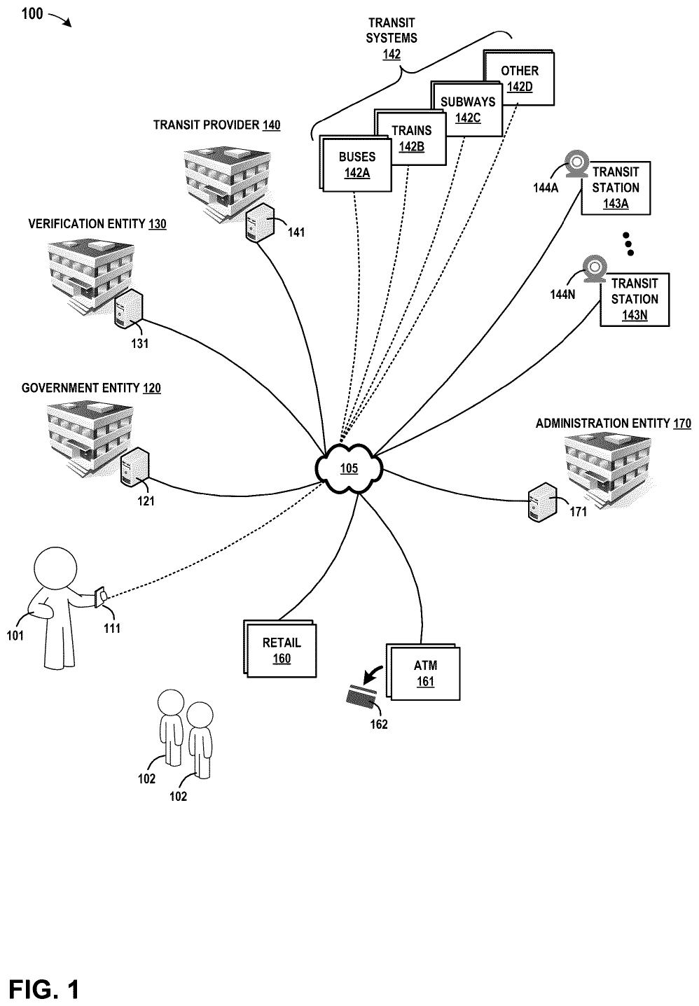

FIG. 1 is a conceptual diagram illustrating an example system for managing, integrating, and/or administering transit infrastructure, in accordance with one or more aspects of the present disclosure. System 100 of FIG. 1 depicts a number of entities, organizations, and/or private enterprises. For example, illustrated in system 100 is government entity 120, verification entity 130, transit provider 140, and administration entity 170. For ease of illustration, only one government entity 120, verification entity 130, transit provider 140, and administration entity 170 is shown in FIG. 1. However, examples described herein may encompass scenarios or implementations in which any number of such entities may contribute to aspects of the techniques described herein.

FIG. 1 illustrates a variety of transit systems that may provide transit and/or mobility services to riders (hereinafter “users”). Such transit systems are represented in FIG. 1 as buses 142A, trains 142B, subways 142C, and/or other transit systems 142D (collectively “transit systems 142”). Transit systems 142 may include various additional infrastructure used to implement transit services. Such additional infrastructure may include real estate, roads, railways, subway tunnels, airfields, and the like (not specifically illustrated in FIG. 1). Such additional infrastructure may also include various buildings, structures, or transit access points, generally depicted in FIG. 1 as transit stations 143A through 143N (collectively “transit stations 143”). Such transit stations 143 may be distributed throughout a geographical region served by any of transit providers 140 and/or transit systems 142. Each of transit stations 143 may be operated by a specific transit provider 140, and may provide access to a specific transit system 142 or to multiple transit systems 142 (or, in general, transit stations 143 may provide access to services provided by a specific transit provider 140 or to multiple transit providers 140).

FIG. 1 also includes user 101, intended to represent a rider or potential rider of one or more of transit systems 142. In some examples, user 101 may possess and operate device 111. In particular, user 101 may use or operate device 111 in connection with riding one or more of transit systems 142. For example, user 101 may use device 111 to access benefits from government entities 120, verify age and/or identity with verification entity 130, and purchase or access transit services transit providers 140.

Device 111 may be implemented by any suitable computing system including any mobile, non-mobile, wearable, and/or non-wearable computing device, which may be a mobile phone or tablet, or a laptop or desktop computing device. In general, device 111 may take any form, which may include a computerized watch, a computerized glove or gloves, a personal digital assistant, a virtual assistant, a gaming system, a media player, an e-book reader, a television or television platform, a bicycle, automobile, or navigation, information and/or entertainment system, or any other type of wearable, non-wearable, mobile, or non-mobile computing device that may perform operations in accordance with one or more aspects of the present disclosure. Alternatively, or in addition to using device 111, user 101 may possess and use a smart, contactless, and/or other card 162 to perform some tasks (e.g., identification, authentication, payment) pertaining to riding one or more of transit systems 142.

Other consumers of transit systems 142 include any number of other users 101 (not specifically shown in FIG. 1) as well as secondary users 102. Secondary users 102 may include various users that are affiliated with or related in some way to user 101. For example, secondary users 102 may be family members of user 101. Secondary users 102 may also include other users having some other relationship with a specific user 101 (secondary users 102 could include care providers, teachers, or guardians of a given user 101, or co-workers, employees, or other users). One or more secondary users 102 may be, like user 101, consumers of transit systems 142. Such secondary users 102 may, in some examples, also operate a computing device and/or use a smart, contactless, and/or other card 162.

Government entity 120 may be a local, state, or federal government or government agency that operates or administers one or more transit systems (e.g., transit systems 142) within its jurisdiction. In most cases, such transit systems are public systems, operated by one or more public transit providers 140. In some cases, however, such transit systems could include private transit systems, operated by privately-run transit providers 140. In other cases, such transit systems may be implemented as a public/private entity partnership. Often, government entity 120 provides funding for one or more transit providers 140, and may set or establish policy pertaining to costs for the use of transit services provided by transit providers 140. In some cases, government entity 120 may establish policy to encourage use of transit service and/or to reduce or eliminate the costs to using such transit services for one or more segments of the population. For example, government entity 120 may establish policy that ensures that users without access to banking services and/or modern mobile devices can nevertheless conveniently use public transit services, perhaps at a reduced cost.

Verification entity 130 may be a public or private entity that authenticates users, and enables users to securely communicate with and/or access services provided by government entity 120 or other entities. In some examples, verification entity 130 may verify the identity, credit history, age, and other information about one or more users 101. Verification entity 130 may supply credentials that enable users 101 to access mobility services provided by transit systems 142, or that allow such users 101 to access online resources pertaining to transit systems 142. Although illustrated as a separate entity in FIG. 1, verification entity 130 may, in some examples, be part of another entity illustrated FIG. 1 (e.g., transit provider 140 may be part of government entity 120, transit provider 140, or administration entity 170). In some examples, verification entity 130 may be a service like login.gov, which was a General Services Administration project of the United States government that was established to develop a secure, user-friendly way for the public to access government websites and services.

Transit provider 140 may be an agency or organization that administers, runs, or otherwise controls the operation of one or more transit systems 142 that provide mobility services to users in a given geographical region. As noted above, transit provider 140 is shown in FIG. 1 as a single entity, but system 100 may include multiple transit providers 140. For example, one transit provider 140 may operate a fleet of busses 142A, another transit provider 140 may operate light rail, commuter, or other train systems 142B, another transit provider 140 may operate a subway systems 142C, and other transit providers 140 may operate other transit systems.

Administration entity 170 may be a private company or other organization that facilitates, provides infrastructure, and/or provides payment processing services to enable users 101 to consume transit services within system 100. For example, in some cases, administration entity 170 may be a bank or other financial institution that performs some aspects of financial and/or other administration of operations performed in FIG. 1. In some examples, for instance, administration entity 170 establishes and/or maintains accounts for users 101 (e.g., financial accounts), allocates funds from government entity 120 to specific users using those accounts, and provides payment infrastructure that enables users to conveniently pay for transit services. In some cases, administration entity 170 might allocate funds from government entity 120 to an institutional account for that government entity 120. In such an example, the administrative account may be used as a source of funds for providing mobility benefits to one or more users 101.

In FIG. 1, each of government entity 120, verification entity 130, transit providers 140, and administration entity 170 may provide the services and perform the operations described herein through control and/or operation of various computing systems. Such computing systems are capable of communicating with other systems, devices, and/or entities illustrated in FIG. 1 over network 105. For example, government entity 120 may control or operate one or more government computing systems 121. Similarly, verification entity 130 may control and/or operate one or more verification computing systems 131. Each of transit providers 140 may control and/or operate one or more transit provider computing systems 141. In addition, administration entity 170 may control and/or operated one or more computing systems 171. In each case, systems 121, 131, 141, and 171 may be implemented as any suitable computing system or collection of computing systems, including one or more server computers, workstations, mainframes, appliances, cloud computing systems, and/or other computing devices that may be capable of performing operations and/or functions described in accordance with one or more aspects of the present disclosure. In some examples, such systems may represent or be implemented through one or more virtualized compute instances (e.g., virtual machines, containers) of a data center, cloud computing system, server farm, and/or server cluster. In these or other examples, such systems may be accessible over a network as a web service, website, or other service platform.

Each of transit stations 143 may include hardware devices and/or infrastructure relating to operation of specific transit system 142 (buses, trains, buildings, real estate). Such devices and/or infrastructure may include systems for enabling access (e.g., gates, turnstiles, card readers, ticketing booths, etc.) to transit system 142 by users 101. In some examples, one or more of transit stations 143 may include one or more sensors 144 (e.g., transit station 143A includes one or more sensors 144A, and in general, transit station 143N includes one or more sensors 144N). Such sensors 144 may be any appropriate sensing device, and could include devices capable of sensing biometric attributes of user 101. For example, such sensors 144 may include facial recognition systems, fingerprint or palm readers, retina scan systems, or any other biometric sensor now known or hereinafter developed. Such sensors 144 may be used to facilitate identification of user 101 and verification that each of user 101 is authorized or is permitted to access transit systems 142 and/or receive mobility services provided by one or more entities depicted in system 100.

Although sensors 144 are shown in FIG. 1 as part of transit stations 143, in other examples, one or more of sensors 144 may alternatively, or in addition, be associated with or included within any of transit systems 142. For example, bus transit system 142A may include a facial recognition system or a palm reader used by users when boarding one of buses 142A. In another example, train transit system 142B may include a camera that is used to identify users through facial recognition, or that is used merely for security or analytics purposes.

In the example of FIG. 1, any of the computing systems or devices illustrated may be capable of communicating over network 105. Network 105 may include or represent any public or private communications network or other network, including the internet. Network 105 is intended to encompass any hardware or other systems required for enabling communications by computing systems and devices illustrated within FIG. 1 or otherwise. To enable communication over 105, various infrastructure devices encompassed by transit stations 143 or transit systems 142 may include communication devices and/or equipment. Accordingly, and although not specifically illustrated in FIG. 1, transit stations 143 may include computing systems capable of communicating over network 105 with other systems. Similarly, the transit infrastructure that physically perform mobility services (e.g., the busses, trains, subway cars, or other mobile systems that transport users 101) may be equipped with wireless communications devices enabling communication over network 105 with other systems, including any of those illustrated in FIG. 1 or described herein.

System 100 of FIG. 1 may include other infrastructure relevant to provision of mobility services. Such infrastructure may include one or more retail outlets 160 and/or one or more ATM machines 161. In some examples, retail outlets 160 may include publicly-run retail stores dedicated to transit services that may sell prepaid transit cards or enable reloading of transit cards with credits. In other examples, one or more of retail outlets 160 may include private retail stores dedicated to the sale of other goods or services (e.g., drugstores, grocery stores, gas stations), but that may also sell prepaid transit cards, enable reloading of transit cards with credits, or otherwise provide products and/or services to support use of transit systems 142. In some cases, both retail outlets 160 and/or ATM machines 161 may be capable of dispensing one or more cards 162 customized for use by a specific user 101.

In one example contemplated by this disclosure, system 100 may represent an environment in which government entity 120 is a state government seeking to integrate and/or modernize an array of transit systems 142 geographically distributed through the state. In such an example, administration entity 170 may be a bank that partners or collaborates with the state government entity 120. Such a partnership or collaboration may enable administration entity 170 (i.e., the bank or financial institution) to provide payment, financial, or operational infrastructure, as well as services and/or expertise to state government entity 120. Administration entity 170 may specifically be able to assist government entity 120 with making public transit more convenient, accessible, efficient, and self-sufficient. Administration entity 170 may also implement processes that allow for the efficient and equitable distribution of public funds to users 101. In other words, government entity 120 may offer qualifying users 101 with mobility benefits, which may enable such users 101 to ride one or more transit systems 142 at a reduced rate or without cost.

Administration entity 170 may also provide systems, services, and/or expertise that make transit systems 142 accessible to those users 101 that wish to use transit systems 142, but that have little or no access to a bank account (i.e., “unbanked” or “underbanked” users 101). Administration entity 170 may provide systems and processes that enable unbanked, underbanked, and/or previously banked users 101 served by government entity 120 to pay for services provided by transit systems 142 and/or encourage users 101 that do not take advantage of services offered by transit to do so with the emergence of new payment solutions and experiences.

Although various examples described herein are described in terms of various entities (e.g., government entity 120, verification entity 130, transit provider 140, administration entity 170) performing specific tasks, it should be understood that in other examples, such tasks may be allocated to or performed by other entities than those described. For example, various tasks described as being performed by administration entity 170 herein could alternatively, or in addition, be performed by government entity 120 in other examples. Similarly, operations described herein as being performed by government computing systems 121, verification computing systems 131, transit provider computing systems 141, and/or computing system 171 could alternatively be performed by other computing systems. For example, operations described herein as being performed by computing system 171 could alternatively, or in addition, be performed by any of computing systems 121, 131, or 141.

In some examples, administration entity 170 may partner with government entity 120 to establish and implement processes and/or policies to that make participation in mobility programs simple and accessible, which will tend to encourage adoption and use of transit systems 142. For instance, administration entity 170 may enable participation in mobility programs (and receipt of mobility benefits from government entity 120) by requiring only minimal information (name, address, source of income). Identity verification of users 101 performed by administration entity 170 (i.e., through computing system 171) may be bi-directional, and could use modern constructs, such as blockchain technologies. Existing verification services or websites (e.g., verification computing system 131, operated by verification entity 130) could also be leveraged, including services previously used by government entity 120. In some cases, administration entity 170 may condition registration of user 101 on receiving an invitation from another referring user 101. Such a referring user 101 could be verified by administration entity 170 (i.e., computing system 171) as originating from a from a validated source. Administration entity 170 may also establish processes for auto-enrollment for “expected” or potential likely users (e.g., existing bank customers, seniors).

In some cases, administration entity 170 may establish that a heightened authentication process be used or even necessary at the point of registration, to ensure that enough information about a given user 101 is known. Such information can be used to address “know your customer” (“KYC”) requirements to enable a bank or other financial institution serving as administration entity 170 to meet anti-money laundering standards, regulatory requirements, or other requirements pertaining to providing financial services to a user. Such heightened information or authentication could equal or at least be similar to the level required to be authorized for an open-loop credit card that might be issued by a bank or financial institution (servicing as administration entity 170). In some cases, payment capabilities might be enabled through a mobile device application executing on device 111. Alternatively, or in addition, computing system 171 may enable payment capabilities through a newly-issued smart card 162 (e.g., dispensed at ATM machine 161), thereby eliminating a requirement that user 101 have a bank account or device 111. Payment capabilities could also be embedded into an existing government-issued identification card (or, possibly, an existing privately-issued card, such as a bank card or university card that might be offered by administration entity 170). Such a card could be used merely as a payment tool (i.e., rather than an “account”), and could be prepaid, reloadable, or a combination of both.

For scenarios in which an account is established by administration entity 170 for some or all of users 101, once a given user's identity has been verified and an account has been “opened” at a bank/administration entity 170 for the user, computing system 171 may communicate with other systems in system 100. For example, computing system 171 may securely communicate with government computing system 121, verification computing system 131, and/or transit provider 140 over network 105. Such communication may include information about accounts established for user 101. Using this information, entities 120, 130, and/or 140 may automatically enroll user 101 in a program (e.g., administered by administration entity 170 or government entity 120) that provides mobility benefits (e.g., public funds enabling user 101 to use transit systems 142).

In some cases, identities of users 101 collected by verification entity 130 may be substantial enough to complete registration with the United States government through a service such as login.gov. In some cases, however, government entity 120 may include additional sources of identity (e.g. state IDs, employer verification) to address an expanded target resident population in the future. In such an example, government entity 120 may communicate additional information about user 101 to administration entity 170 (e.g., by enabling government computing system 121 to communicate such additional information over network 105 to computing system 171). Such additional information may include resident identity information that government entity 120 and/or verification entity 130 has collected and verified and that administration entity 170 may require for “know your customer” or anti-money laundering purposes. Such information might be required to open a money movement account (resident name, address, source of income/wealth). This may be particularly important for unbanked and/or underbanked users 101, since such users 101 may lack a substantial credit and/or account history. Also, government entity 120 may maintain the resident identities for users 101, but government entity 120 and administration entity 170 may establish a federated identity solution (e.g., using a system similar to OpenID Connect). In some examples, administration entity 170 may maintain an aggregate/institutional account for the benefit of government entity 120 (or a specific entity) with a subledger that tracks balances for each of users 101 that ties to a payment vehicle (e.g. debit card).

Government entity 120 may, in some cases, provide Universal Basic Income (UBI) benefits to some of users 101 and/or secondary users 102, which may involve establishing a bank account (e.g., at administration entity 170) to enable such users 101 to receive income. Users 101 may pay for use of transit systems 142 using funds drawn from the account. In some examples, when user 101 pays for services provided by transit systems 142, each of secondary users 102 associated with that user 101 may receive some form of fee forgiveness.

In one specific example, government entity 120 may establish a transit or mobility program that furnishes qualifying users a set amount of money each month to be used for public transportation. Government entity 120 may fund accounts for users 101 or for general population use through specific government allocations, employer contributions, or general public funds. In some cases, as described above, money could be deposited into a bank account and a given user 101 could use a newly-issued card that is to be used for transit. When user 101 signs up for such an account, that user might designate or choose a financial institution (from a network of banks or financial institutions) and may also provide any background information required by that financial institution, thereby satisfying any KYC requirements. In some cases, the chosen financial institution may serve as administration entity 170.

As part of this process, information about user 101 or that user's benefits could be pre-filled or approved before being presented to user 101 (e.g., through a user interface presented by device 111). After registration, features/benefits of the program could be ready to be delivered upon signup, thereby enhancing usability, reducing friction, and encouraging use. In registering for UBI, a user 101 may select which financial institution is to be used to manage balances and payments for that user 101. Following the selection of the institution, government entity 120 may provide information to the financial institution or administration entity 170 (e.g., over network 105). Thus, when user 101 visits a branch of the bank (administered by administration entity 170) or signs up online, the amount of additional paperwork and effort is reduced as the financial institution (administration entity 170) already has most of the records needed to open an account.

Additionally, employers can provide payments through the system for users, and may, in some cases, serve as a source of funds or information for government entity 120. For example, an employer in the relevant geographical area may provide transportation benefits to offset the costs of commuting to an office as part of an employee's compensation package. Additionally, the employer can provide information to government entity 120 regarding an employee's income level and whether that employee would qualify for income-based transportation benefits.

In some examples, device 111 may execute an application developed for transit use with features as described herein. Such an application may be a newly-developed transit-specific app, but could also be an extension to an existing app. Such an application may be developed to make its use relatively seamless for those banked users 101 that are comfortable using smart/mobile devices (i.e., device 111), and preferably much more user-friendly than legacy government-run programs.

For users 101 willing and/or able to use a mobile device app, additional benefits and conveniences might be available. Users may, for instance, receive notifications on device 111 for specific event-driven or destination-driven benefits that may be of value. For example, during heat wave, information about free bus rides to certain cooling centers might be distributed.

In some examples, envelopes, stashes, or sub-accounts can be used for specific purposes, and could be automatically established or allocated for various users 101. Such automatic allocation (or self-assembly of envelopes) might be based on which benefits or envelopes a particular user 101 qualifies for, and this information could be derived from what administration entity 170 knows about a given user and that user's registration/qualifications. Such sub-accounts could also be sized by government entity 120 or an employer.

In some cases, it may be appropriate to limit the use of funds (e.g., narrow the use of funds to specific envelopes or limit to closed-loop scenarios) for users 101 identified as “risky,” those for which administration entity 170 has limited information, or those users have a limited KYC workup. To implement such limitations on fund use, administration entity 170 may use merchant category codes, or the user's location (e.g., a California resident can't use a transit card in New York). A payment system implemented by administration entity 170 could be configured to only approve payment based on the merchant code of the transaction, similar to how limitations on types of transactions work in the health savings account context (e.g., HSA cards). For example, user 101 might purchase a train ticket at a general retail outlet 160, but administration entity 170 might prevent user 101 from purchasing other items such as food or household goods.

In some examples, purpose-specific funds could be used with an “account” established at administration entity 170 (demand deposit account, prepaid, etc.) and held by government entity 120, but managed by user 101. Such an account may be where financial benefits from government entity 120 will be deposited. User 101 can use the account to pay for state services (i.e., public transportation, EV, SNAP . . . ). That user's employer (or government entity 120) may put money into these accounts directly. A state-held account and customer bank account could be reconciled daily to show total available balances.

Government entity 120 and/or administration entity 170 may establish policies to prevent a rider with limited funds from being stranded without access to transit systems 142. For instance, computing system 171 may enable a “one more trip” policy that enables user 101 to carry a negative balance for one ride (or one trip, which may involve transfers). Such a policy would enable user 101 to return home safely, even while carrying negative balance.

In some examples, computing system 171 is implemented so that any signup process presented to users 101 is readily accessible when needed, so a user can enroll, receive benefits, and start using the benefits right at the bus station or other transit station 143. A user might, for example, enroll for benefits from government entity 120 by accessing government computing system 121 over network 105 using device 111 and get a virtual card loaded with eligible benefits at a given transit station 143. In some cases, user 101 might learn about benefits when visiting a transit station 143 and might see an advertisement with a QR code describing mobility benefits. User 101 might then scan the QR code using device 111, launch an app that collects data to determine eligibility, and view information presented at device 111 about available benefits. If benefits are available, user 101 might push a virtual card to device 111 with funds loaded based on eligible benefits, making the benefits usable for a trip immediately on one or more of transit systems 142.

For mobile application users, mobility benefits could be overlaid on maps in mapping apps executing on device 111 (e.g., Google Maps). In such an example, a map presented at device 111 could be annotated with mobility benefits, such as rewards available and costs, for various destinations chosen by the user. Similarly, mobility benefits could be integrated into a mobile device mapping app executing at device 111.

For example, suppose user 101 wishes to travel from transit station 143A to transit station 143N (or generally, from point A to point B). User 101 might interact with a mapping application executing on device 111 and obtain directions using one or more of transit systems 142. At that time, device 111 might also present a travel plan or itinerary, which might indicate that user 101 should walk to a specific identified bus stop or transit station 143, ride a specific bus to a train station or other transit station 143, and then take a specific train ride on train transit system 142B. User 101 might also be presented with information indicating whether the user has enough mobility benefits (e.g., loaded on their mobile device, account, or physical debit card) to pay for the trip from transit station 143A to transit station 143N (or point A to point B).

System 100 of FIG. 1 might use devices capable of sensing biometric attributes of users 101. In some cases, artificial reality glasses or other AR/VR devices might be used as a device 111 or at transit stations 143. In other cases, transit stations 143 may use biometric devices, such as a retina scan, for authentication. Watches, rings, voiceprints, also could be used, whether or not linked to a separate device 111. In one example, user 101 might have an account holding transit dollars, and systems associated with transit options (the bus, subway, train, or any of transit stations 143) could use facial recognition or palm sensors to allow that user to be identified and then travel using the transit dollars in the account.

In some cases, it may be useful to enable a digital payments network to be used as a sharing solution, so that if user 101 has mobility benefits, that user 101 can share or transfer those benefits with others, such as secondary users 102 (e.g., family members, employees, school children on a school field trip). In one example, when user 101 pays for transit services direct from a bank account (or otherwise), that user's family gets fee forgiveness for some period of time. In some examples, a single pool of funds might be shared by an entire family for transportation (i.e., one account, multiple users). Additionally, groups such as school field trips might be able to avoid having to pay or individually register children for reduced/free fares. Instead, the group as a whole can be registered for the reduced/free transit fares.

Some destinations within system 100 could be “free,” meaning transit costs to such destinations are not charged to some qualifying users (or not charged to any users). Free destinations might include public facilities, such as the local courthouse or library or other public facility. To prevent users from traveling to a “free” destination simply to avoid charges for traveling to “non-free” destination that is near a free destination (e.g., a restaurant across the street from the courthouse), a system at the free destination (where the “free” destination could operate as a transit station 143) might be used to enable users to “check in” or “tap-in,” at which point transportation charges are reversed.

Some destinations might not be free, but could offer a discount or limited free availability (e.g., schools between certain morning hours on weekdays, enabling teachers to ride to work for free). Free or reduced cost rides could similarly be provided for seniors and/or for other users traveling to an appointment (e.g., a medical or government authorized appointment). In some cases, a fee forgiveness program could be implemented, where frequent riders receive benefits or discounts for volume transit (which may encompass travel by all family members). For example, for a family that travels four times per month, each family member receives a discount on the fifth and subsequent rides. Also, a referral program could be established to encourage others to use public transit (e.g., user 101 refers a friend who actually ends up using public transit, user 101 receives a free ride or $5 in benefits).

Administration entity 170 may establish policies to implement a deductible-like plan. For example, after user 101 uses transit systems 142 a threshold number of times, fees may be eliminated (or reduced). Until the threshold number of rides is reached, a fee might be incurred for each ride (acting as a “copay”). Administration entity 170 may establish policies that are more sophisticated, requiring computing system 171 to implement such policies using logic-based or rule-based algorithms. Such policies may be designed to encourage use of public transit.

Government entity 120 may partner with private services, like ride sharing services (e.g., Uber or Lyft), enabling users to allocate benefits to those services. Where benefits are government-provided, the Uber/Lyft driver may be effectively paid by the state in an arrangement where the state is effectively “renting” that service. Note that for some situations, like where there are a large number of riders, it may be more economical to user a ride sharing service than to use other transit systems 142.

When providing benefits for private services, one or more transit systems 142 may condition such benefits on user 101 using some public transit. For example, if user 101 actually gets on the bus after getting out of the Uber/Lyft, computing system 171 may perform transactions that cause the connecting Uber/Lyft ride to be free for user 101. The concepts described herein could encompass all forms of private transportation, beyond Uber/Lyft, and potentially extending to cab services, private bus lines, airlines, etc.

Mobility benefits provided by government entity 120 could be tied to peak/off-peak times, so that users receive more benefits immediately, or in the future, by scheduling transit use when public transit tends to be underused. Mapping software executing on device 111 may be used to help with this determination and steer users 101 into favorable timeframes. An app executing on device 111 might notify user 101 that user 101 has received $5 in benefits because of a ride taken during an off-peak timeframe.

Administration entity 170 could establish policies, implemented by computing system 171, that tie incentives to user volumes at certain times of day (e.g., if a train from point of A to B is full at certain times of day, and basically empty at other times of day). In such an example, computing system 171 may reduce the fare automatically or confer more mobility benefits if the user travels during off-peak times. This concept might be considered to be similar policies in place for electric vehicle charging.

In some cases, using public transit frequently or for a period of time (e.g., a month) might result in some type of credit or reward. Those credits could be used for other public resources, like campgrounds, museums, or other sites. Computing system 171 may implement policies that make rewards useful in other areas, whether transportation related (e.g., airline miles or benefits within the state) or not (general benefits).

Administration entity 170 may receive interchange revenue by handling financial transactions within system 100. In some examples, some or all of such revenue may be allocated to underserved groups, contributions to savings accounts to help build financial stability for various users 101, and/or to further investments in public transit.

In some examples administration entity 170 may control and/or operate various ATM machines 161 within system 100. In such an example, administration entity 170 may reconfigure existing ATMs to enable top-up or reloading of travel cards (in addition to app-based and website-based reloading). Closed loop (prepaid) systems could dispense cards 162 through the ATM. For users 101 who are bank customers of administration entity 170, a variety of features and experiences may be tied into user accounts. For users 101 who are not customers, such users 101 might have limited capabilities to fund their accounts, get balances, etc. In some cases, a closed loop card (i.e., one that can be used only to pay for transit services) dispensed at an ATM might be convertible to an open-loop card (i.e., usable for non-transit services) based on the user providing other input and satisfying KYC requirements.

ATM machines 161 may serve a dual role as both an ATM machine and service station for transit-related tasks. ATM machines 161 may also adjust operations based on the type of card 162 a user 101 inserts into an ATM machine 161. For instance, in an example that can be described in the context of FIG. 1, user 101 inserts card 162 into an ATM machine 161. ATM machine 161 recognizes card 162 as a transit card (rather than a banking-related card, such as a debit card). In response, ATM machine 161 presents a user interface (e.g., display screen, interactive voice prompt) that presents transit-related information and/or services. Such transit-related information could involve providing a schedule of upcoming transit services that might be relevant to user 101. Such transit-related services could involve enabling user 101 to obtain balance information, top-up or reload card 162, dispense new cards 162, or perform other transit-related functions. Where ATM machine 161 recognizes card 162 as a debit card, on the other hand, ATM machine 161 may present a user interface enabling ATM-related functions.

Enabling unbanked and/or underbanked users to use benefits (whether government-funded, employer-funded, or otherwise) to pay for public transit may be serve as the basis for establishing creditworthiness. By providing benefits, such users have the opportunity to build credit over time through contributions using transportation and mobility benefits. For example, if a user pays for some fraction of transit benefits, the user builds credit. If the state or other entity pays for such benefits, the user's credit score is not affected. In such examples, users 101 can build credit safely with micro-payments, locks, and controls. User 101 may use a card or an app to pay for transportation and then may use a credit card with locks and controls to immediately pay the fare when user 101 is enroute to the chosen destination.

In a system such as system 100 illustrated in FIG. 1, government entities 120 and transit providers 140 can implement modern payment platforms (e.g., contactless platforms) and still avoid leaving behind users 101 who do not have access to smartphones or bank accounts. For example, transit providers 140 may provide options enabling all users 101 to pay for or reload transit cards in cash. Transit providers 140 should continue to allow users 101 to pay in cash to reload transit cards via vending machines or an outside retail network (e.g., retail outlets 160). Transit providers 140 that are upgrading or implementing a payment system could still enable unbanked users 101 to refill their virtual accounts with cash at neighborhood convenience stores.

Transit providers 140 may also enable prepaid cards to operate with tap services. Prepaid, bank-branded cards are another option for users 101 for those users 101 that do not have a bank account or a smartphone. Transit providers 140 could partner with a prepaid-card program manager to provide prepaid cards to the provider's unbanked ridership, or transit providers 140 could issue privately labeled cards in partnership with a bank and processing company.

Transit providers 140 may also provide protections for users 101 having a negative balance. When a transit fare is higher than the amount left on a card 162, this negative balance could prevent user 101 from exiting a transit station 143. A policy that enables user 101 to take one more trip on a bus when they have a negative balance would prevent such a result.

Transit providers 140 could make moving between cities simple and easy. Often, legacy transit systems 142 may make moving between cities involve moving between operators with different payment mediums. Transit providers 140 could integrate the payment processes and enable users 101 to use payment mediums interchangeably, or at least simple and easy.

Transit providers 140 could replace legacy payment systems and agency-issued tickets or cards with fully digital open-loop payments systems, which accept all debit, credit, and mobile payments and are more readily interoperable between different transit agencies and shared mobility operators. This would enable transit users to pay for transit with whichever means of payment they prefer. However, some considerations—such as ‘know your customer’ requirements—may mean open payment solutions might not be able to serve all customer segments. In some cases, if a transit operator (e.g., any of transit providers 140) plans to offer payment media that can be used outside of transit, significant marketing effort may be needed to position those products as a universal payment solution instead of transit smartcards.

Transit providers 140 should establish policies based on an assumption that banked and unbanked users 101 both want to pay for transit with the same means of payment they already use for other things. Similarly, transit providers 140 should establish policies based on an assumption that, for the most part, unbanked users 101 are not deterred from using digital payments for transit. Unbanked and lower income individuals are more likely to indicate they would use prepaid cards (government issued or otherwise), and less likely to use other means. Whereas those who are banked are more likely to indicate they would use mobile phone-based payments and debit cards.

Techniques described herein may provide certain technical advantages. For instance, by modernizing payment platforms, transit systems 142 may operate more reliably and in a more cost-effective and automated way, perhaps while still requiring fewer employees and other resources. Further, by integrating payment and other processes across multiple disparate transit systems 142, users 101 will more effectively be able to use a diverse set of transit systems 142 and reach destinations more quickly and efficiently. Further, by modernizing payment platforms in a way that ensures access to transit systems by all segments of the population, transit systems will be more widely used across all demographics, and thereby better serve the public.

Transit and mobility systems and related benefits are one primary use case contemplated by systems, techniques, and processes described herein. As described herein, such systems may be implemented through a collaboration between a governmental entity (e.g., a state government) and a financial institution (e.g., a banking institution). However, other government benefits or services beyond transit could follow a similar program or pattern. Further, such programs could involve a collaboration with another type of private entity, or, in some cases without a collaboration with any private entity. Accordingly, concepts described herein could apply to other governmental programs and other allocations of public funds. Such public funds might or might not include allocations of purpose-driven funds for a specific purpose.

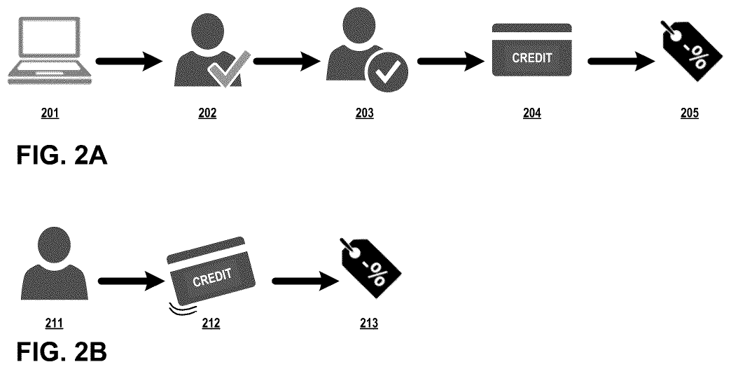

FIG. 2A is a conceptual diagram illustrating a process by which a user registers to pay for transit services using a credit card, in accordance with one or more aspects of the present disclosure. Operations illustrated in FIG. 2A are described herein within the context of system 100 of FIG. 1, and represent one possible way in which users 101 may register to pay for transit services in system 100.

In FIG. 2A, and in accordance with one or more aspects of the present disclosure, user 101 may start a registration process established by government entity 120 (201). For instance, in an example that can be described with reference to FIG. 1, device 111 (operated by user 101) detects input and outputs a signal over network 105. Government computing system 121 of detects a signal over network 105 and determines that the signal corresponds to a request, by user 101 operating device 111, to register for transit services benefits.

Verification entity 130 may verify the user's identity (202). For instance, continuing with the example and with reference to FIG. 1, government computing system 121 outputs signals over network 105. Device 111 detects the signals over network 105. In response to the signals, device 111 begins interacting with verification computing system 131. Based on such interactions, which may be derived from input detected at device 111 (e.g., from user 101), verification computing system 131 verifies the identity of user 101.

Verification entity 130 may verify the user's age (203). For instance, still with reference to FIG. 1, and based on further interactions between device 111 and verification computing system 131, verification computing system 131 collects further information about user 101. Based on this further information, verification computing system 131 verifies the age of user 101.

Transit provider 140 may store payment information (204). For instance, still continuing with the example being described in the context of FIG. 1 and FIG. 2A, verification computing system 131 outputs further signals over network 105 after verifying the identity and age of user 101. Device 111 detects the further signals over network 105 and determines that the signals correspond to a request for payment information. Device 111 detects input and outputs information over network 105. Verification computing system 131 receives the information and determines that the information includes credit card payment information for user 101. Verification computing system 131 stores the credit card payment information (e.g., credit card number and security code) for use in connection with transit services provided in system 100 by one or more of transit systems 142.

Each of transit systems 142 may link transit benefits or discounts to the stored payment information (205). For instance, again with reference to FIG. 1, and after verification computing system 131 collects payment information, verification computing system 131 outputs signals over network 105. Government computing system 121 detects the signals and determines that the signals correspond to a request for information about mobility or transit benefits available for the verified user 101 from government entity 120. Government computing system 121 responds to the request with information about mobility or transit benefits. Verification computing system 131 receives the information and communicates information about the mobility or transit benefits to one or more transit provider computing systems 141 over network 105. Each of transit provider computing systems 141 detect one or more signals and determine that the information includes information that links transit benefits to use of the credit card of user 101.

FIG. 2B is a conceptual diagram illustrating a process by which a user uses a credit card to pay for transit services, in accordance with one or more aspects of the present disclosure. Operations illustrated in FIG. 2B are described herein within the context of system 100 of FIG. 1, and represent one way in which user 101 may pay for transit services provided by transit provider 140A (through transit system 142A) in system 100 using a credit card.

In FIG. 2B, and in accordance with one or more aspects of the present disclosure, user 101 visits transit station 143A (see FIG. 1), seeking to use transit services (211). Sensor 144A at transit station 143A detects an interaction (e.g., a tap, swipe) with a credit card (212). Sensor 144A outputs information about the interaction to transit provider computing system 141A operated by transit provider 140A. Transit provider computing system 141A uses the information about the interaction to identify user 101.

Transit provider computing system 141A determines whether user 101 is entitled to any mobility benefits from government entity 120 (213). For example, again referring to FIG. 1 and based on the determination of whether user 101 is entitled to mobility benefits, transit provider computing system 141A processes payment for the requested transit services provided by transit provider 140A. In some cases, some or all of such payment is charged to the card associated with user 101. In other cases, some or all of such payment is provided through funds allocated by government entity 120.

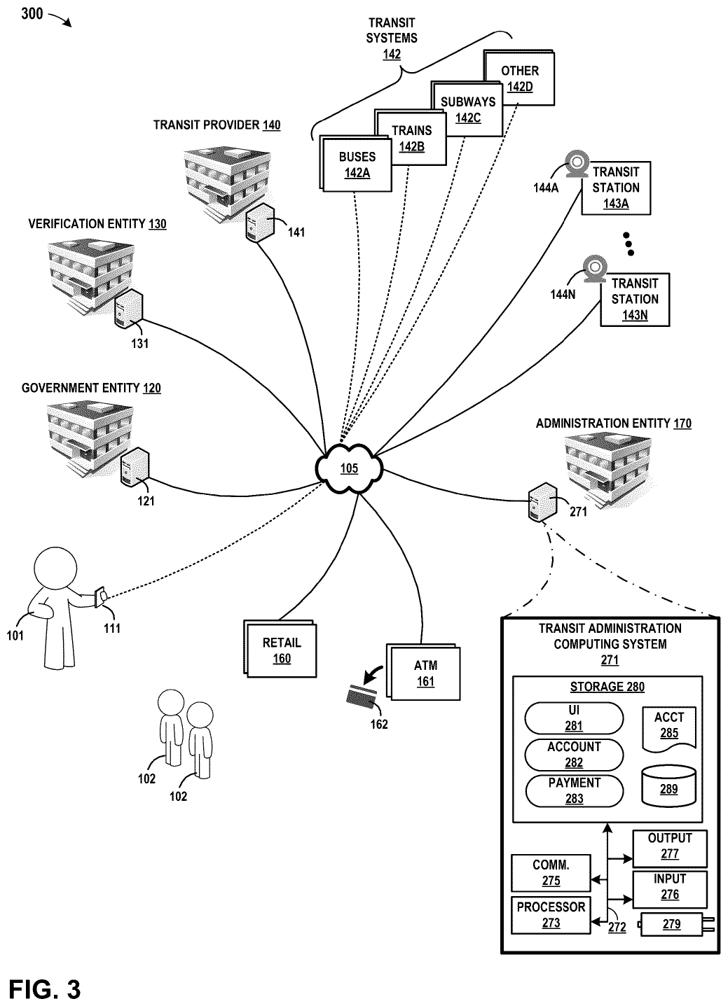

FIG. 3 is a conceptual diagram and block diagram illustrating an example computing system for managing, integrating, and/or administrating transit infrastructure, in accordance with one or more aspects of the present disclosure. System 300 of FIG. 3 includes many of the same elements of system 100 of FIG. 1, and in general, like-numbered elements illustrated in FIG. 3 correspond to elements similarly illustrated and numbered in FIG. 1.

FIG. 3 does, however, illustrate a block diagram of computing system 271. In examples described in connection with FIG. 3, computing system 271 may correspond to, or may be considered an example or alternative implementation of computing system 171 of FIG. 1. For ease of illustration, computing system 271 is depicted in FIG. 3 as a single computing system. However, in other examples, computing system 271 may comprise multiple devices or systems, such as systems distributed across a data center or multiple data centers. For example, separate computing systems may implement functionality performed by each of user interface module 281, account module 282, and payment module 283. Alternatively, or in addition, computing system 271 (or various modules illustrated in FIG. 3 as included within computing system 271) may be implemented through distributed virtualized compute instances (e.g., virtual machines, containers) of a data center, cloud computing system, server farm, and/or server cluster.

In FIG. 3, computing system 271 is illustrated as including underlying physical hardware that includes power source 279, one or more processors 273, one or more communication units 275, one or more input devices 276, one or more output devices 277, and one or more storage devices 280. Storage devices 280 may include user interface module 281, evaluation module 282, and refinement module 283. One or more of the devices, modules, storage areas, or other components of computing system 271 may be interconnected to enable inter-component communications (physically, communicatively, and/or operatively). In some examples, such connectivity may be provided by through communication channels, which may include a system bus (e.g., communication channel 272), a network connection, an inter-process communication data structure, or any other method for communicating data.

Power source 279 of computing system 271 may provide power to one or more components of computing system 271. One or more processors 273 of computing system 271 may implement functionality and/or execute instructions associated with computing system 271 or associated with one or more modules illustrated herein and/or described below. One or more processors 273 may be, may be part of, and/or may include processing circuitry that performs operations in accordance with one or more aspects of the present disclosure. One or more communication units 275 of computing system 271 may communicate with devices external to computing system 271 by transmitting and/or receiving data, and may operate, in some respects, as both an input device and an output device. In some or all cases, communication unit 275 may communicate with other devices or computing systems over network 305 or over other networks.

One or more input devices 276 may represent any input devices of computing system 271 not otherwise separately described herein, and one or more output devices 277 may represent any output devices of computing system 271 not otherwise separately described herein. Input devices 276 and/or output devices 277 may generate, receive, and/or process output from any type of device capable of outputting information to a human or machine. For example, one or more input devices 276 may generate, receive, and/or process input in the form of electrical, physical, audio, image, and/or visual input (e.g., peripheral device, keyboard, microphone, camera). Correspondingly, one or more output devices 277 may generate, receive, and/or process output in the form of electrical and/or physical output (e.g., peripheral device, actuator).

One or more storage devices 280 within computing system 271 may store information for processing during operation of computing system 271. Storage devices 280 may store program instructions and/or data associated with one or more of the modules described in accordance with one or more aspects of this disclosure. One or more processors 273 and one or more storage devices 280 may provide an operating environment or platform for such modules, which may be implemented as software, but may in some examples include any combination of hardware, firmware, and software. One or more processors 273 may execute instructions and one or more storage devices 280 may store instructions and/or data of one or more modules. The combination of processors 273 and storage devices 280 may retrieve, store, and/or execute the instructions and/or data of one or more applications, modules, or software. Processors 273 and/or storage devices 280 may also be operably coupled to one or more other software and/or hardware components, including, but not limited to, one or more of the components of computing system 271 and/or one or more devices or systems illustrated or described as being connected to computing system 271.

Data store 289 of computing system 271 may represent any suitable data structure or storage medium for storing information relating to accounts maintained for users 101, verification processes for verifying, authenticating, and/or auditing use of transit systems 142 by users 101, funding sources and policies for use of transit systems 142, and other information pertaining to the administration of system 300 of FIG. 3 or aspects of system 300. The information stored in data store 289 may be searchable and/or categorized such that one or more modules within computing system 271 may provide an input requesting information from data store 289, and in response to the input, receive information stored within data store 289. Data store 289 may be primarily maintained by account module 282.

User interface module 281 may perform functions relating to presenting one or more user interfaces to users 101 (e.g., through devices 111) or receiving information derived from input detected at devices 111. In some examples user interfaces presented by user interface module 281 may include information about transit fares, locations of transit stations 143, information about schedules for various transit systems 142, information about discounted fares or mobility benefits provided by government entity 120, maps or annotated maps illustrating routes and costs associated with a trip, and other information. Account module 282 may perform functions relating to maintaining one or more accounts for each of users 101 or, in some cases, for government entity 120. Payment module 283 may perform functions relating to processing payment for fares charged to users 101 for trips taken within system 100 using transit systems 142. Payment module 283 may apply algorithms for calculating fares that tend to encourage use of transit systems 142 that enforce a policy established by government entity 120. Payment module 283 may also provide information to user interface module 281 to enable user interface module 281 to generate notifications or information to be presented to one or more users 101 about costs for use of transit systems 142.

Modules illustrated in FIG. 3 (e.g., user interface module 281, account module 282, payment module 283) and/or illustrated or described elsewhere in this disclosure may perform operations described using software, hardware, firmware, or a mixture of hardware, software, and firmware residing in and/or executing at one or more computing devices. For example, a computing device may execute one or more of such modules with multiple processors or multiple devices. A computing device may execute one or more of such modules as a virtual machine executing on underlying hardware. One or more of such modules may execute as one or more services of an operating system or computing platform. One or more of such modules may execute as one or more executable programs at an application layer of a computing platform. In other examples, functionality provided by a module could be implemented by a dedicated hardware device.

Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may interact with and/or operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated.

Further, each module, data store, component, program, executable, data item, functional unit, or other item illustrated within a storage device may be implemented in various ways. For example, each module, data store, component, program, executable, data item, functional unit, or other item illustrated within a storage device may be implemented as a downloadable or pre-installed application or “app.” In other examples, each module, data store, component, program, executable, data item, functional unit, or other item illustrated within a storage device may be implemented as part of an operating system executed on a computing device.

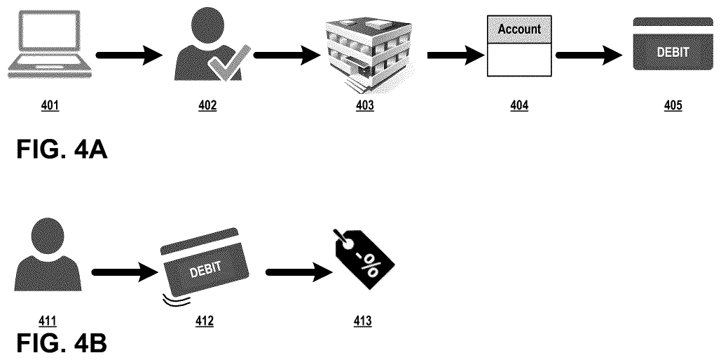

FIG. 4A is a conceptual diagram illustrating a process by which a user registers to pay for transit services using an alternative payment method, in accordance with one or more aspects of the present disclosure. Operations illustrated in FIG. 4A are described herein within the context of system 300 of FIG. 3, and represent one possible way in which users 101 may register to pay for transit services in system 300. In some examples, users 101 in FIG. 4A may register for mobility benefits provided by government entity 120.

FIG. 4A differs from FIG. 2A in some respects. For example, rather than requiring user 101 to enter credit card information, a bank or other financial institution (e.g., administration entity 170) may use information provided by government entity 120 (e.g., via an API exposed by computing system 271) to establish an “account” at the bank or financial institution. Accordingly, at least some aspects of computing system 271 may be operated and/or controlled by a bank or other financial institution (i.e., administration entity 170 in FIG. 3 can be a bank or other financial institution). In some examples, the “account” established at administration entity 170 is not necessarily a fully-enabled or normal bank account, but might instead be an account that can be used to link to transit benefits from government entity 120. In some cases, the “account” might be a hybrid between an institutional account and individual consumer accounts, where funds are drawn from an institutional account into a user account, as needed.

Further, in some examples, the account established at administration entity 170 for user 101 may include or may enable sub-accounts or stashes that hold funds to be used for a specific purpose (e.g., transit services). Funds could be allocated as needed from government entity 120 or from an account associated with government entity 120. In some examples, a batch reconciliation could be performed periodically (e.g., at the end of the day). Such an implementation might parallel some “university card” programs offered by commercial banks to college students. Alternatively, or in addition, such an implementation might leverage user information derived from data collected by the login.gov system. Some implementations could, in some cases, involve a full “know your customer” (KYC) work-up that requires a user to provide substantial background information in exchange for establishing an account and/or issuing a payment card to be used for transit services.

In FIG. 4A, and in accordance with one or more aspects of the present disclosure, computing system 271 of FIG. 3 may initiate or enable a registration process for a user (401). For instance, with reference to FIG. 3 and FIG. 4A, device 111 (operated by user 101) detects input and outputs a signal over network 105. Communication unit 275 of computing system 271 detects a signal and outputs information about the signal to user interface module 281. User interface module 281 determines that the signal corresponds to a request, by user 101, to register for transit or mobility benefits that may be available through government entity 120.

Computing system 271 may enable verification entity 130 to verify user 101 (402). For instance, again with reference to FIG. 3, user interface module 281 of computing system 271 causes communication unit 275 to output signals over network 105. Device 111 detects signals over network 105 and based on the signals, presents a user interface at device 111. Device 111 detects interactions with the presented user interface and communicates with verification computing system 131 over network 105. Verification computing system 131 verifies, based on communications with device 111 over network 105, the identity, age, and/or income level of user 101.

Administration entity 170 may receive, through computing system 271, information about user 101 (403). For instance, continuing with the example being described in the context of FIG. 3, verification computing system 131 outputs a signal over network 105. Communication unit 275 of computing system 271 detects the signal over 105 and outputs information about the signal to account module 282. Account module 282 determines that the signal includes information from verification entity 130 (i.e., verification computing system 131). Account module 282 further determines that the information includes information about the identity, age, and/or income level of user 101.

Computing system 271 may establish an account (404). For instance, again referring to FIG. 3, account module 282 uses one or more application programming interface (API) calls to establish an account for user 101 at administration entity 170. Account module 282 causes communication unit 275 to interact with government computing system 121 over network 105. Based on such interactions, account module 282 determines whether transit services benefits are available to user 101. Account module 282 establishes account 285 for user 101 and stores information about the account in data store 289. Account module 282 links account 285 to transit benefits provided by government entity 120 (e.g., based on the interactions with government computing system 121).

Computing system 271 may produce a debit card to enable user 101 to use transit services (405). For instance, still referring to FIG. 3, account module 282 outputs information to payment module 283. Payment module 283 funds account 285, drawing funds from government entity 120 as a result of interactions with government computing system 121. In some examples, payment module 283 of computing system 271 may cause one or more cards 162 to be established or created. Each such 162 may be issued by administration entity 170 and funded from account 285. Card 162 may, for example, be a contactless debit card for the use by users 101 authorized to use account 285 (e.g., user 101 and/or secondary users 102). In some cases, such cards 162 may be physically provided to user 101 (e.g., by physical delivery, or through one of ATM machines 161).

FIG. 4B is a conceptual diagram illustrating a process by which a user uses an alternative payment method to pay for transit services, in accordance with one or more aspects of the present disclosure. Operations illustrated in FIG. 4B are described herein within the context of system 300 of FIG. 3, and represent one way in which users 101 may pay for transit services in system 300 using an alternative payment method established through the process described in connection with FIG. 4A.

In FIG. 4A, and in accordance with one or more aspects of the present disclosure, user 101 visits transit station 143A, seeking to use one or more transit services and/or mobility benefits (411). For instance, with reference to an example that can be described in the context of FIG. 3, user 101 brings card 162 to transit station 143A, seeking to access transit services provided by, for example, transit provider 140A.

Computing system 271 may detect input enabling identification of verified user 101 (412). For instance, continuing with the example, sensor 144A at transit station 143A detects input that it determines corresponds to a tap, swipe, or other action involving card 162. Sensor 144A outputs a signal over network 105. Communication unit 275 of computing system 271 detects a signal over network 105 and outputs information about the signal to payment module 283. Payment module 283 determines that the signal includes information identifying card 162. Payment module 283 uses the information to identify and access account 285 associated with user 101. Payment module 283 determines, based on account 285, that user 101 qualifies for mobility benefits and/or has sufficient funds to access the desired transit services.

Computing system 271 may enable the user to access to transit services (413). For instance, again referring to FIG. 3, payment module 283 causes communication unit 275 to output a signal over network 105. Transit station 143A receives a signal over network 105 and determines that the signal is a command to enable the requested transit services for user 101 (i.e., enable user 101 to ride the bus, train, subway). Transit station 143A enables transit services for user 101 (e.g., by providing access to user 101 through a turnstile at transit station 143A, by providing an indication to the driver of one of buses 142A that appropriate payment for user 101 has been received, or through some other appropriate method). Payment module 283 also determines one or more transactions to apply to account 285 associated with the transit services user 101 is accessing. Payment module 283 updates account 285 to account for the transit services used by user 101 and to account for any benefits applied to pay for the transit services. In some examples, such updates may include deducting funds, adding funds from a source of mobility benefits, applying discounts associated with mobility benefits, and/or applying other adjustments to account 285. Payment module 283 outputs information to data store 289, causing data store 289 to log information about transactions associated with the transit services used by user 101. In some examples, user interface module 281 may cause communication unit 275 of computing system 271 to output a signal over network 105 that device 111 uses to present a user interface (e.g., providing to user 101 information about payment).

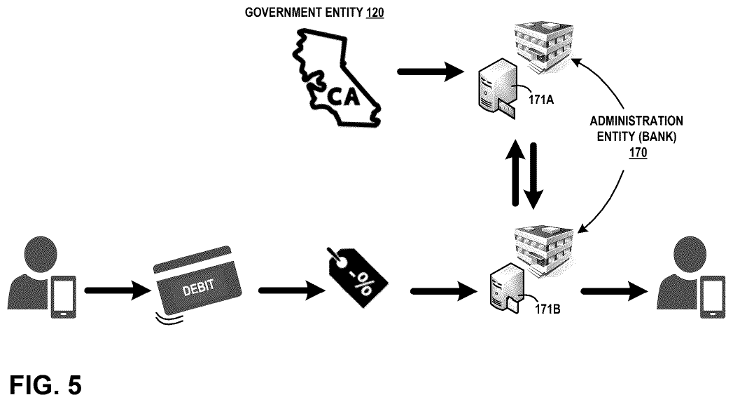

FIG. 5 is a conceptual diagram illustrating a process by which a financial institution allocates funds for transit services to users, in accordance with one or more aspects of the present disclosure. In FIG. 5, administration entity 170 described and illustrated in FIG. 1 and FIG. 3 may be a bank or other financial institution that performs financial, operational, and other tasks for various services in collaboration with government entity 120. In the example illustrated in FIG. 5, government entity 120 may be the State of California, and the services described may be transit services throughout the state.

Various account maintenance arrangements may be established between government entity 120 and administration entity 170. In some examples, funds could be held on behalf of each user 101 (i.e., each “rider” or “customer”) by administration entity 170. In other examples, a single unified account could be used for a group of users 101 (e.g., administered by computing system 171A), and those funds could be allocated to users through subaccounts (administered by computing system 171B). Alternatively, instead of administration entity 170 holding “funds” for the purposes of transit, users 101 could be furnished with a predefined count or quantity of “free” trips that can be taken, either indefinitely or within a time-boxed period of time (e.g., 40 trips per month, which equates to 2 trips per day, 5 days per week, 4 weeks in a month).

Other arrangements might use “ringfenced” purpose-specific funds within an “account” (inclusive of demand deposit accounts, prepaid, and other bank instruments). In such examples, the funds might not actually be ‘housed’ within the account holder's underlying account. Instead, the funds may be held in an institutional account (e.g., for government entity 120 or an agency thereof) but be linked to the user's payment vehicle (e.g., debit card) and available on-demand and reconciled in real-time or end-of-day (batch) between accounts with the ‘available’ balance shown to the user through digital interface and/or statement enabled or provided by government entity 120 and/or administration entity 170.

The funds could be purpose-specific (e.g., transit, SNAP, Electronic Benefits Transfer, gas inflation reduction, electric vehicle charging/reimbursement), and the merchant classification code could be provided by the payment network. Such a code could be used to drive decisioning in real-time by a computing system (e.g., computing system 171B in FIG. 5) around where to pull funds from (e.g., a transit ‘stash’ would be deducted if a transaction matching a transit specific merchant name was made; otherwise, the transaction would draw from a general balance).

In general, any given user 101 might not have access to these ‘ringfenced’ funds for general spending (e.g., if user 101 overdraws a general funds balance, these funds are not a ‘fallback’ or ‘grace’ balance). A ringfenced ‘stash’ would generally be funded by an external entity, such as government entity 120 or an employer—this could replace the way pre-tax transit benefits, health savings accounts, and other accounts work today. In another example, and in the case of a ‘general’ disbursement (e.g., COVID stimulus, universal basic income, tax refund), the funds could flow down the same ‘rails’ but would be deposited in the user's general funds/balance for spending on anything (no restrictions)—the ‘funder’ could determine the type of payment at the time of payment.

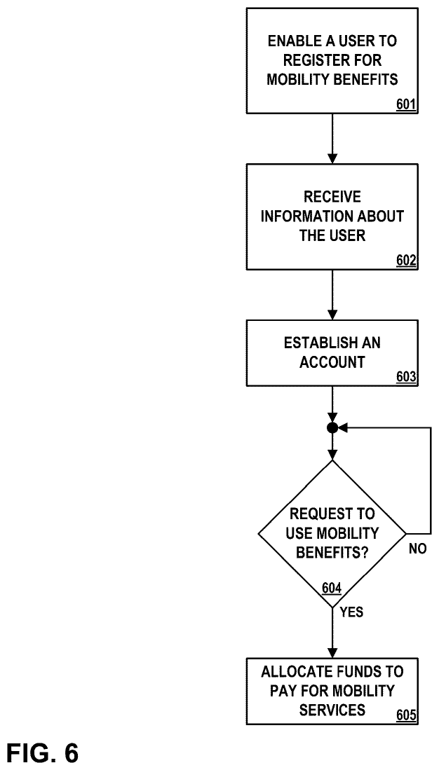

FIG. 6 is a flow diagram illustrating operations performed by an example computing system in accordance with one or more aspects of the present disclosure. FIG. 6 is described below within the context of computing system 170 of FIG. 1. In other examples, operations described in FIG. 6 may be performed by one or more other components, modules, systems, or devices. Further, in other examples, operations described in connection with FIG. 6 may be merged, performed in a difference sequence, omitted, or may encompass additional operations not specifically illustrated or described.

In the process illustrated in FIG. 6, and in accordance with one or more aspects of the present disclosure, computing system 171 may enable a user to register for mobility benefits (601). For example, with reference to FIG. 1, computing system 171 detects signals over network 105 that it determines corresponds to a request, by a user operating device 111, to register for mobility benefits provided by government entity 120. Computing system 171 outputs signals over 105 that cause device 111 to interact with verification computing system 131 and verify the age, identity, and other information about user 101.

Computing system 171 may receive information about user 101 (602). For example, verification computing system 131 verifies information about the age, identity, and other information about user 101, through interactions with device 111 over network 105. Verification computing system 131 outputs signals over network 105. Computing system 171 detects signals over network 105 and determines that the signals include information about user 101.

Computing system 171 may establish an account (603). For example, computing system 171 uses the information about user 101 to determine what extent, if any, user 101 is entitled to mobility benefits offered by government entity 120. In some examples, computing system 171 may interact with government computing system 121 to perform such a determination. Computing system 171 establishes an account for user 101, where the account may be configured differently based on whether user 101 is entitled to certain mobility benefits from government entity 120.

Computing system 171 may receive a request to use mobility benefits (604). For example, computing system 171 waits for a signal over network 105 (NO path from 604). Eventually, user 101 visits transit station 143A and interacts with one or more sensors 144A at transit station 143A. One or more of sensors 144A output a signal over network 105. Computing system 171 detects a signal over network 105 and determines that the signal corresponds to a request, by user 101 to use transit system 142 at transit station 143A (YES path from 604).

Computing system 171 may allocate funds to pay for mobility services (605). For example, computing system 171 determines, based on the type of account previously established for user 101, how payment for mobility services provided by transit system 142A should made. In some examples, computing system 171 determines that user 101 is entitled to mobility benefits, and in such an example, some or all of the funds required for the requested transit services are allocated from funds originally provided by government entity 120. In other examples, computing system 171 may determine that user 101 is not entitled to mobility benefits, and in such an example, some or all of the funds required for the requested transit services area allocated from funds originally provided by user 101 through other sources.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The disclosures of all publications, patents, and patent applications referred to herein are hereby incorporated by reference. To the extent that any such disclosure material that is incorporated by reference conflicts with the present disclosure, the present disclosure shall control.

For ease of illustration, only a limited number of devices (e.g., device 111, government computing system 121, verification computing system 131, transit provider computing system 141, computing system 171, computing system 271, as well as others) are shown within the Figures and/or in other illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The Figures included herein each illustrate at least one example implementation of an aspect of this disclosure. The scope of this disclosure is not, however, limited to such implementations. Accordingly, other example or alternative implementations of systems, methods or techniques described herein, beyond those illustrated in the Figures, may be appropriate in other instances. Such implementations may include a subset of the devices and/or components included in the Figures and/or may include additional devices and/or components not shown in the Figures.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced figures in order to avoid obscuring such concepts.

Accordingly, although one or more implementations of various systems, devices, and/or components may be described with reference to specific Figures, such systems, devices, and/or components may be implemented in a number of different ways. For instance, one or more devices illustrated herein as separate devices may alternatively be implemented as a single device; one or more components illustrated as separate components may alternatively be implemented as a single component. Also, in some examples, one or more devices illustrated in the Figures herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated in various Figures herein may alternatively be implemented as part of another device or component not shown in such Figures. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, or optical disk storage, magnetic disk storage, or other magnetic storage devices, flash memory, or any other medium that can be used to store desired program code in the form of instructions or data structures and that can be accessed by a computer. Also, any connection may properly be termed a computer-readable medium. For example, if instructions are transmitted from a website, server, or other remote source using a wired (e.g., coaxial cable, fiber optic cable, twisted pair) or wireless (e.g., infrared, radio, and microwave) connection, then the wired or wireless connection is included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structure or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, a mobile or non-mobile computing device, a wearable or non-wearable computing device, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

What is claimed is:

1. A method comprising:
receiving, by a computing system controlled by a financial institution, information about a user, wherein the information about the user includes information about age and wealth of the user;
determining, by the computing system and based on the information about the user and mobility benefit policies established by an organization, mobility benefits available to the user across a plurality of transit systems;
establishing, by the computing system, a mobility account for the user at the financial institution, wherein the mobility account is configured to enable access to the mobility benefits available to the user across the plurality of transit systems;
detecting, by the computing system, a request to access mobility benefits;
determining, by the computing system, a transit system of the plurality of transit systems associated with the request; and
performing a transaction, by the computing system and using the mobility account, to pay for mobility benefits associated with use of the transit system by the user.

2. The method of claim 1, wherein receiving information about the user includes:
enabling the user to register for mobility services using a verification system operated by an entity that is independent from the financial institution; and
receiving, from the verification system, the information about the user.

3. The method of claim 1,
wherein establishing the mobility account includes determining a source of funds for the mobility benefits; and
wherein performing a transaction includes allocating funds from the source of funds.

4. The method of claim 3, wherein the organization is a state government, and wherein determining the source of funds includes:
identifying at least one of an employer and the state government as the source of funds.

5. The method of claim 1, wherein the mobility account has a current funds balance, wherein the use of the transit system by the user has a cost, and wherein detecting a request to access mobility benefits includes:
detecting a request to travel using the transit system;
determining that the current funds balance is less than the cost; and
enabling, responsive to determining that the travel using the transit system brings the user to a location near a home associated with the user, access to the travel using the transit system.

6. The method of claim 1,
wherein receiving information about the user includes receiving information about facial features of the user; and
wherein detecting a request to access mobility benefits includes using facial recognition to identify, by the computing system, the user at a transit station.

7. The method of claim 1, wherein establishing the mobility account includes issuing a physical mobility benefit device to the user, and wherein detecting a request to access mobility benefits includes:
detecting, at a transit station, the physical mobility benefit device.

8. The method of claim 1, wherein establishing the mobility account includes issuing a physical mobility benefit device to the user, and wherein detecting a request to access mobility benefits includes:
detecting, at an automated teller machine that is capable of communicating with the computing system, the physical mobility benefit device.

9. The method of claim 8, wherein the automated teller machine includes a display, and wherein the method further comprises:
responsive to detecting the physical mobility benefit device, presenting, by the automated teller machine, a user interface on the display that is specific to the mobility benefits available to the user.

10. The method of claim 1, further comprising:
detecting, by the computing system, that the user has traveled to a designated destination that the mobility benefits policies identify as a destination qualifying for special mobility benefits; and
responsive to determining that the user has traveled to the designated destination, conferring a mobility benefit to the user.

11. The method of claim 10, further comprising:
wherein conferring the mobility benefit to the user includes reimbursing, to the mobility account, funds used for traveling to the designated destination.

12. The method of claim 10, wherein detecting that the user has traveled to the designated destination includes:
detecting a physical check-in procedure performed by the user at the designated destination.

13. The method of claim 10, wherein detecting that the user has traveled to the designated destination includes:
identifying the user at the designated destination using facial recognition.

14. The method of claim 1, wherein determining mobility benefits to the user includes determining mobility benefits available to a secondary user associated with the user, the method further comprising:
detecting, by the computing system and based on input from the secondary user, a request to access mobility benefits; and
enabling, by the computing system, the secondary user to access the mobility benefits.

15. A computing system comprising processing circuitry and a storage device, wherein the computing system is controlled by a financial institution and includes processing circuitry having access to the storage device, and wherein the processing circuitry is configured to:
receive information about a user, wherein the information about the user includes information about age and wealth of the user;
determine, based on the information about the user and mobility benefit policies established by an organization, mobility benefits available to the user across a plurality of transit systems;
establish a mobility account for the user at the financial institution, wherein the mobility account is configured to enable access to the mobility benefits available to the user across the plurality of transit systems;
detect a request to access mobility benefits;
determine a transit system of the plurality of transit systems associated with the request; and
perform a transaction, using the mobility account, to pay for mobility benefits associated with use of the transit system by the user.

16. The computing system of claim 15, wherein to receive information about the user, the processing circuitry is further configured to:
enable the user to register for mobility services using a verification system operated by an entity that is independent from the financial institution; and
receive, from the verification system, the information about the user.

17. The computing system of claim 15, wherein to establish the mobility account the processing circuitry is further configured to:
determine a source of funds for the mobility benefits.

18. The computing system of claim 17, wherein the organization is a state government, and wherein to determine the source of funds, the processing circuitry is further configured to:
identify at least one of an employer and the state government as the source of funds.

19. The computing system of claim 15, wherein the mobility account has a current funds balance, wherein the use of the transit system by the user has a cost, and wherein to detect a request to access mobility benefits, the processing circuitry is further configured to:
detect a request to travel using the transit system;
determine that the current funds balance is less than the cost; and
enable, responsive to determining that the travel using the transit system brings the user to a location near a home associated with the user, access to the travel using the transit system.

20. A non-transitory computer-readable medium comprising instructions that, when executed, cause processing circuitry of a computing system controlled by a financial institution to:
receive information about a user, wherein the information about the user includes information about age and wealth of the user;
determine, based on the information about the user and mobility benefit policies established by an organization, mobility benefits available to the user across a plurality of transit systems;
establish a mobility account for the user at the financial institution, wherein the mobility account is configured to enable access to the mobility benefits available to the user across the plurality of transit systems;
detect a request to access mobility benefits;
determine a transit system of the plurality of transit systems associated with the request; and
perform a transaction, using the mobility account, to pay for mobility benefits associated with use of the transit system by the user.
